(19) United States
(12) Patent Application Publication
(10) Pub. No.: US 2015/0064460 A1
(43) Pub. Date: Mar. 5, 2015

(54) CARRIER FILM FOR TRANSPARENT CONDUCTIVE FILMS AND LAMINATE

(71) Applicant: NITTO DENKO CORPORATION, Osaka (JP)

(72) Inventors: Masamichi MATSUMOTO, Osaka (JP); Tatsumi AMANO, Osaka (JP); Toru ISEKI, Osaka (JP); Hiromoto HARUTA, Osaka (JP)

(73) Assignee: NITTO DENKO CORPORATION, Osaka (JP)

(21) Appl. No.: 14/464,218

(22) Filed: Aug. 20, 2014

(30) Foreign Application Priority Data
Aug. 30, 2013 (JP) 2013-180466

(51) Int. Cl. C09J 7/02; B32B 27/36; C09J 133/08; B32B 27/08

(52) U.S. Cl. CPC C09J 7/0217; B32B 27/08; B32B 27/36; C09J 133/08; B32B 2250/02; B32B 2250/244; C09J 2201/122; C09J 2201/606; C09J 2203/326; C09J 2433/00
USPC 428/355 AC; 428/423.1

(57) ABSTRACT

A carrier film for transparent conductive films of the invention includes a support and a pressure-sensitive adhesive layer provided on at least one side of the support, wherein the pressure-sensitive adhesive layer is made from a pressure-sensitive adhesive composition including: a (meth)acryl-based polymer (A) having a glass transition temperature of −50° C. or lower and obtained by polymerization of a monomer component containing an alkyl(meth)acrylate and a hydroxyl group-containing monomer; an isocyanate crosslinking agent (B); and a catalyst (C) having an iron active center. The carrier film for transparent conductive films, with which the formation of irregularities on an adherend surface and zipping can be prevented.

### BACKGROUND OF THE INVENTION

1. Field of the Invention

The invention relates to a carrier film, which includes a support and a pressure-sensitive adhesive layer, for transparent conductive films. The invention also relates to a laminate including a transparent conductive film and the carrier film for transparent conductive films.

2. Description of the Related Art

In touch panels, liquid crystal display panels, organic EL panels, electrochromic panels, electronic paper elements and the like, demands for elements using a film substrate obtained by providing a transparent electrode on a plastic film have recently been increasing.

An ITO thin film (In—Sn composite oxide) or a silver nanowire is now used as a material of a transparent electrode, and a thickness of a thin film substrate including the above ITO thin film or the silver nanowire tends to become thin year by year.

In many cases, the thin film substrate having an ITO thin coating is provided with a functional layer such as an anti-reflection (AR) layer for improving visibility, a hard coat (HC) layer for preventing scratches, an anti-blocking (AB) layer for preventing blocking, or an oligomer-blocking (OB) layer for preventing clouding upon heating.

Under these circumstances, a surface protective film or the like is used in the state of being attached to an optical member such as an ITO thin film in processing step, transporting step or the like for the purpose of preventing scratches, stains and the like. For example, Patent Document 1 discloses that a thin surface protective film is used in the state of being attached to an optical member.

To improve productivity, however, the substrate with the functional layer is directly subjected to manufacturing processes such as the formation and patterning of the ITO thin coating, and in some cases, the transparent conductive film with the functional layer undergoes very large changes in temperature when placed in a heated environment, washed with water, and subjected to other processes. Such temperature changes cause the problem of significant deformation (such as waviness) of the transparent conductive film (or the functional layer itself when the functional layer is provided). For this problem, for example, Patent Document 2 discloses that a carrier film for transparent conductive films includes a support and a pressure-sensitive adhesive layer, wherein the irregularities of the surface of the pressure-sensitive adhesive layer to be attached to the transparent conductive film are controlled to be smaller.

### PRIOR ART DOCUMENTS

### Patent Documents

Patent Document 1: JP-A-2007-304317

Patent Document 2: WO 2013/094542 A

### SUMMARY OF THE INVENTION

### Problems to be Solved by the Invention

In the carrier film disclosed in Patent Document 2 for transparent conductive films, the pressure-sensitive adhesive layer is made from a pressure-sensitive adhesive containing, as a base polymer, a (meth)acryl-based polymer produced with butyl acrylate as a principal monomer so that the irregularities of the surface of the pressure-sensitive adhesive layer can be controlled to be smaller. This means that the pressure-sensitive adhesive layer is designed to have a relatively high glass transition temperature. The pressure-sensitive adhesive layer disclosed in Patent Document 2 generally has a glass transition temperature of about −40° C. When the carrier film disclosed in Patent Document 2 is used on a transparent conductive film, the above problem can be solved, and the formation of irregularities on the surface of the transparent conductive film (irregularities on the adherend surface) can be prevented during the process of peeling off the transparent conductive film from the carrier film.

It has been newly found that when the carrier film disclosed in Patent Document 2 is used, a phenomenon called “zipping” occurs in some cases, although it is practical and useful enough to prevent the formation of irregularities on the adherend surface. “Zipping” is a phenomenon in which a transparent conductive film not being smoothly released from a carrier film repeatedly stops and causes a crackling sound during the process of peeling off the transparent conductive film from the carrier film. If zipping occurs in a case where the transparent conductive film has high adhesive strength to the adherend, undesirable events can occur, such as cracking of the ITO coating and formation of a residue after the release. On the other hand, it is conceivable that zipping can be reduced if the pressure-sensitive adhesive layer is designed to have a low glass transition temperature or if the degree of crosslinking of the pressure-sensitive adhesive layer is reduced using a certain crosslinking agent. However, when such means are used, the formation of irregularities on the adherend surface cannot be sufficiently prevented.

It is an object of the invention to provide a carrier film for transparent conductive films, with which the formation of irregularities on an adherend surface and zipping can be prevented.

It is a further object of the invention to provide a laminate including such a carrier film and a transparent conductive film.

### Means for Solving the Problems

The present inventors have intensively studied so as to achieve the above object and found that the above object can be achieved by using the carrier film for transparent conductive films described below, and thus the invention has been completed.

The invention relates to a carrier film for transparent conductive films, including a support and a pressure-sensitive adhesive layer provided on at least one side of the support, wherein

the pressure-sensitive adhesive layer is made from a pressure-sensitive adhesive composition including:

a (meth)acryl-based polymer (A) having a glass transition temperature of −50° C. or lower and obtained by polymerization of a monomer component containing an alkyl(meth)acrylate and a hydroxyl group-containing monomer;

an isocyanate crosslinking agent (B); and

a catalyst (C) having an iron active center.

In the carrier film, the monomer component used to form the (meth)acryl-based polymer (A) preferably contains 65% by weight or more of the alkyl(meth)acrylate and 1 to 25% by weight of the hydroxyl group-containing monomer based on the total weight of the monomer component.

In the carrier film, the pressure-sensitive adhesive composition preferably contains 1 to 30 parts by weight of the isocyanate crosslinking agent (B) based on 100 parts by weight of the (meth)acryl-based polymer (A).

In the carrier film, the catalyst (C) having an iron active center is preferably an iron chelate compound. The pressure-sensitive adhesive composition preferably contains 0.002 to 0.5 parts by weight of the catalyst (C) having an iron active center based on 100 parts by weight of the (meth)acryl-based polymer (A).

In the carrier film, the monomer component used to form the (meth)acryl-based polymer (A) preferably further contains a carboxyl group-containing monomer. The monomer component preferably contains 0.005 to 5% by weight of the carboxyl group-containing monomer based on the total weight of the monomer component.

In the carrier film, the pressure-sensitive adhesive composition preferably further includes a compound (D) capable of undergoing keto-enol tautomerism. The compound (D) capable of undergoing keto-enol tautomerism is preferably a β-diketone. The weight ratio (D/C) of the compound (D) capable of undergoing keto-enol tautomerism to the catalyst (C) having an iron active center is preferably from 3 to 70.

The invention also relates to a laminate, including:

the above carrier film; and

a transparent conductive film placed on the carrier film, wherein

a surface of the pressure-sensitive adhesive layer of the carrier film is attached at least one surface of the transparent conductive film.

As the laminate is exemplified such that the transparent conductive film includes a support and a transparent conductive layer and the surface of the pressure-sensitive adhesive layer of the carrier film is attached to a surface of the support opposite to a support surface in contact with the transparent conductive layer.

In the laminate is exemplified such that the transparent conductive film includes a support, a transparent conductive layer and a functional layer provided on a surface of the support opposite to a support surface in contact with the transparent conductive layer, and the surface of the pressure-sensitive adhesive layer of the carrier film is attached to a surface of the functional layer opposite to a functional layer surface in contact with the support.

### Effect of the Invention

The carrier film of the invention for transparent conductive films has a pressure-sensitive adhesive layer that is made from a pressure-sensitive adhesive composition containing the (meth)acryl-based polymer (A) with a glass transition temperature of −50° C. or lower, the isocyanate crosslinking agent (B), and the catalyst (C) having an iron active center. When the carrier film of the invention is used on a transparent conductive film, the carrier film can be subjected to manufacturing processes accompanied by changes in temperature, such as heating and washing with water, transporting processes, and other processes while attached to the transparent conductive film. After these processes, the carrier film can be peeled off from the transparent conductive film without causing either zipping or irregularities on the adherend surface.

The pressure-sensitive adhesive layer according to the invention is made from a pressure-sensitive adhesive composition containing, as a base polymer, the (meth)acryl-based polymer (A) with a low glass transition temperature of −50° C. or lower. Therefore, the pressure-sensitive adhesive layer is soft enough to prevent zipping. The isocyanate crosslinking agent (B) is selected from a variety of crosslinking agents and used, which makes it possible to reduce the crosslink density of the pressure-sensitive adhesive layer and thus prevent zipping.

However, when the (meth)acryl-based polymer (A) with a relatively low glass transition temperature is used in combination with the isocyanate crosslinking agent (B), the pressure-sensitive adhesive composition can be crosslinked at a relatively low rate, and the resulting pressure-sensitive adhesive layer can be relatively soft and have an easily deformable adhesive surface, so that the adherend surface may be more likely to have irregularities. In the invention, the catalyst (C) having an iron active center is used for the isocyanate crosslinking agent (B), so that the crosslinking rate can be increased even with a small amount of addition of the catalyst, which makes it possible to form a hard pressure-sensitive adhesive layer and prevent the formation of irregularities on the adherend surface. If a tin-based catalyst is used for the isocyanate crosslinking agent (B), a small amount of addition of the tin-based catalyst will provide a low crosslinking rate, so that the formation of irregularities on the adherend surface cannot be prevented enough. On the other hand, as the amount of addition of the tin-based catalyst increases, the pot life of the pressure-sensitive adhesive composition decreases, and productivity decreases.

In addition, when the carrier film of the invention is used on a transparent conductive film, the transparent conductive film as the adherend can be prevented from becoming wrinkled or being scratched, and the shape of the transparent conductive film can be kept intact.

### BRIEF DESCRIPTION OF THE DRAWINGS

FIG. 1(a) is a schematic diagram of a laminate including: a carrier film having a pressure-sensitive adhesive layer; and a functional layer-bearing transparent conductive film attached to the surface of the pressure-sensitive adhesive layer; and

FIG. 1(b) is a schematic diagram of a laminate including: a carrier film having a pressure-sensitive adhesive layer; and a transparent conductive film attached to the surface of the pressure-sensitive adhesive layer.

### DETAILED DESCRIPTION OF THE PREFERRED EMBODIMENTS

### 1. Carrier Film for Transparent Conductive Films

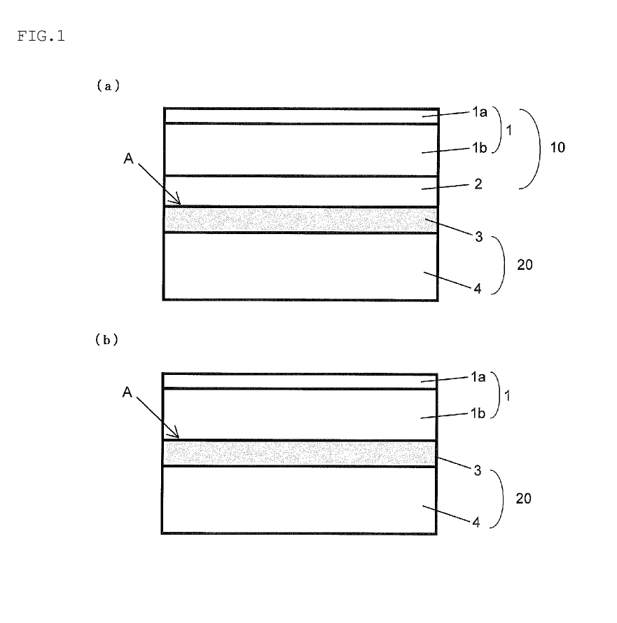

Hereinafter, embodiments of the invention will be described with reference to FIG. 1. It will be understood that the embodiments shown in FIG. 1 is not intended to limit the invention.

A carrier film 20 of the invention for transparent conductive films includes a support 4 and a pressure-sensitive adhesive layer provided on at least one side of the support 4. The pressure-sensitive adhesive layer 3 has an adhesive surface A opposite to an adhesive surface in contact with the support. As shown in FIG. 1(a), a functional layer-bearing transparent conductive film 10 may be provided, which has a functional layer 2. In this case, the adhesive surface A is in contact with the functional layer 2. As shown in FIG. 1(b), a transparent conductive film 1 with no functional layer may also be provided. In this case, the transparent conductive film 1 includes a transparent conductive layer 1a and a support 1b, and the adhesive surface A is in contact with the surface of the support (base material) 1b (or in contact with the side of the support 1b opposite to its side on which the transparent conductive layer 1a is provided).

### (1) Pressure-Sensitive Adhesive Layer

In the invention, the pressure-sensitive adhesive layer is made from a pressure-sensitive adhesive composition containing a (meth)acryl-based polymer (A) with a glass transition temperature of −50° C. or lower, an isocyanate crosslinking agent (B), and a catalyst (C) having an iron active center.

### <(Meth)Acryl-Based Polymer (A)>

The (meth)acryl-based polymer (A) is obtained by polymerization of a monomer component containing an alkyl(meth)acrylate and a hydroxyl group-containing monomer, in which the glass transition temperature (Tg) of the (meth)acryl-based polymer (A) is adjusted to −50° C. or lower. The glass transition temperature of the (meth)acryl-based polymer (A) can be adjusted within the range by appropriately changing the type or composition ratio of the monomer component. To prevent zipping, the (meth)acryl-based polymer (A) preferably has a glass transition temperature of −55° C. or lower, more preferably −60° C. or lower, even more preferably −65° C. or lower. On the other hand, if the glass transition temperature is too low, the pressure-sensitive adhesive may lose cohesive strength and have too high adhesive strength or cause adhesive deposit. Therefore, the glass transition temperature is preferably −100° C. or higher.

The alkyl(meth)acrylate may be, for example, one having an alkyl group of 2 to 14 carbon atoms. As a principal monomer, the alkyl(meth)acrylate preferably has an alkyl group of 4 to 14 carbon atoms, more preferably an alkyl group of 6 to 14 carbon atoms, even more preferably an alkyl group of 6 to 9 carbon atoms, for the purpose of adjusting the glass transition temperature of the (meth)acryl-based polymer (A) to −50° C. or lower. Examples of the alkyl(meth)acrylate having an alkyl group of 2 to 14 carbon atoms include ethyl(meth)acrylate, n-butyl(meth)acrylate (BA), tert-butyl(meth)acrylate, isobutyl(meth)acrylate, hexyl(meth)acrylate, 2-ethylhexyl(meth)acrylate (2EHA), n-octyl(meth)acrylate, isooctyl(meth)acrylate, n-nonyl(meth)acrylate, isononyl(meth)acrylate, n-decyl(meth)acrylate, isodecyl(meth)acrylate, n-dodecyl(meth)acrylate, n-tridecyl(meth)acrylate, n-tetradecyl(meth)acrylate, etc. These may be used singly or in combination of two or more. Among these, n-butyl(meth)acrylate (BA) and 2-ethylhexyl(meth)acrylate (2EHA) are preferable, in particular n-butyl(meth)acrylate (BA) is preferable.

Particularly when the pressure-sensitive adhesive layer is required to be lightly peelable, the alkyl(meth)acrylate to be used preferably has an alkyl group of 6 to 14 carbon atoms, and the content of the alkyl(meth)acrylate having an alkyl group of 6 to 14 carbon atoms is preferably 50% by weight or more, more preferably 60% by weight or more, even more preferably 80% by weight or more, further more preferably 90% by weight or more, based on the total weight of the alkyl(meth)acrylates used.

The content of the alkyl(meth)acrylate in the monomer component is preferably 65% by weight or more, more preferably 70% by weight or more, even more preferably 80% by weight or more, further more preferably 90% by weight or more. If the content of the alkyl(meth)acrylate is less than 65% by weight, the content of the hydroxyl group-containing monomer described below or other monomers will be relatively high so that the (meth)acryl-based polymer (A) may tend to have a higher glass transition temperature.

The hydroxyl group-containing monomer may have an unsaturated double bond-containing polymerizable functional group such as a (meth)acryloyl group or a vinyl group and a hydroxyl group capable of reacting with the isocyanate crosslinking agent (B). Examples of the hydroxyl group-containing monomer include hydroxyalkyl(meth)acrylates such as 2-hydroxyethyl(meth)acrylate, 2-hydroxypropyl(meth)acrylate, 3-hydroxypropyl(meth)acrylate, 2-hydroxybutyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate, and [4-(hydroxymethyl)cyclohexyl]methyl acrylate.

Examples of the hydroxyl group-containing monomer also include N-hydroxyalkyl(meth)acrylamides such as N-methylolacrylamide,

N-methylolmethacrylamide, N-(2-hydroxyethyl)acrylamide, N-(2-hydroxyethyl)methacrylamide, N-(2-hydroxypropyl)acrylamide, N-(2-hydroxypropyl)methacrylamide, N-(1-hydroxypropyl)acrylamide, N-(1-hydroxypropyl)methacrylamide, N-(3-hydroxypropyl)acrylamide, N-(3-hydroxypropyl)methacrylamide, N-(2-hydroxybutyl)acrylamide, N-(2-hydroxybutyl)methacrylamide, N-(3-hydroxybutyl)acrylamide, N-(3-hydroxybutyl)methacrylamide, N-(4-hydroxybutyl)acrylamide, and N-(4-hydroxybutyl)methacrylamide.

Among these hydroxyl group-containing monomers, hydroxyalkyl(meth)acrylates such as 2-hydroxyethyl(meth)acrylate and 4-hydroxybutyl(meth)acrylate are preferred in view of their polymerization ability and reactivity with the isocyanate crosslinking agent (B), and 4-hydroxybutyl acrylate is particularly preferred. These hydroxyl group-containing monomers may be used singly or in any combination.

The content of the hydroxyl group-containing monomer in the monomer component is preferably from 1 to 25% by weight, more preferably from 3 to 20% by weight, even more preferably from 6 to 17% by weight, further more preferably from 8 to 15% by weight. The content of the hydroxyl group-containing monomer should be ensured so that zipping can be prevented by forming a crosslink with the isocyanate crosslinking agent (B). In this point of view, the content of the hydroxyl group-containing monomer should preferably be 1% by weight or more. In particular, when the pressure-sensitive adhesive layer is required to be lightly peelable, the content of the hydroxyl group-containing monomer is preferably 11% by weight or more.

Besides the alkyl(meth)acrylate and the hydroxyl group-containing monomer, the monomer component may contain one or more polymerizable monomers having an unsaturated double bond-containing polymerizable functional group such as a (meth)acryloyl group or a vinyl group. Such other polymerizable monomers should be appropriately selected and used so as to allow the (meth)acryl-based polymer (A) to have a glass transition temperature of −50° C. or lower. Such other polymerizable monomers may be used singly or in any combination. The content of the other polymerizable monomer(s) in the monomer component is preferably 44% by weight or less, more preferably 40% by weight or less, even more preferably 30% by weight or less, further more preferably 20% by weight or less, still more preferably 10% by weight or less, yet more preferably 5% by weight or less.

The polymerizable monomer may be a carboxyl group-containing monomer. The carboxyl group-containing monomer can be used to make the crosslinking reaction more efficient and to reduce the adhesive strength at high peel rate. Examples of the carboxyl group-containing monomer include (meth)acrylic acid, carboxyethyl acrylate, carboxypentyl acrylate, itaconic acid, maleic acid, fumaric acid, crotonic acid, and isocrotonic acid. Among these carboxyl group-containing monomers, acrylic acid is preferred in view of polymerization ability, cohesiveness, cost and versatility.

The content of the carboxyl group-containing monomer in the monomer component is preferably 5% by weight or less, more preferably from 0.005 to 2% by weight, even more preferably from 0.01 to 1% by weight, further more preferably from 0.02 to 0.5% by weight, still more preferably from 0.02 to 0.1% by weight.

It is possible to appropriately use, as the other polymerizable monomers, monomer components for improving cohesive strength and heat resistance, such as a sulfonic acid group-containing monomer, a phosphoric acid group-containing monomer, a cyano group-containing monomer, a vinyl ester monomer and an aromatic vinyl monomer; and monomer components having a functional group serving as a cross-linking base point, such as an acid anhydride group-containing monomer, an amide group-containing monomer, an amino group-containing monomer, an epoxy group-containing monomer, N-acryloyl morpholine and a vinylether monomer. These monomers may be used alone, or two or more kinds of them may be used in combination.

Examples of the acid anhydride group-containing monomer include maleic anhydride, itaconic anhydride and the like.

Examples of the sulfonic acid group-containing monomer include styrenesulfonic acid, allylsulfonic acid, 2-(meth)acrylamide-2-methylpropanesulfonic acid, (meth)acrylamidepropanesulfonic acid, sulfopropyl(meth)acrylate, (meth)acryloyloxynaphthalenesulfonic acid and the like.

Examples of the phosphoric acid group-containing monomer include 2-hydroxyethylacryloyl phosphate, 2-(phosphonooxy)ethyl methacrylate, and 3-chloro-2-(phosphonooxy)propyl methacrylate.

Examples of the cyano group-containing monomer include acrylonitrile and the like.

Examples of the vinyl ester monomer include vinyl acetate, vinyl propionate, vinyl laurate and the like.

Examples of the aromatic vinyl monomer include styrene, chlorostyrene, chloromethylstyrene, α-methylstyrene and the like.

Examples of the amide group-containing monomer include acrylamide, diethylacrylamide and the like.

Examples of the amino group-containing monomer include N,N-dimethylaminoethyl(meth)acrylate, N,N-dimethylaminopropyl(meth)acrylate and the like.

Examples of the epoxy group-containing monomer include glycidyl(meth)acrylate, allyl glycidyl ether and the like.

Examples of the vinyl ether monomer include methyl vinyl ether, ethyl vinyl ether, isobutyl vinyl ether and the like.

The (meth)acryl-based polymer (A) used in the invention can be obtained by polymerization of a monomer component. There is no particular limitation on a method for polymerizing the (meth)acryl-based polymer (A). It is possible to polymerize the (meth)acryl-based polymer (A) by known methods such as solution polymerization, emulsion polymerization, bulk polymerization and suspension polymerization, and solution polymerization is more preferable from the viewpoints of workability and the like. The polymer to be obtained may be any of a homopolymer, a random copolymer, a block copolymer and the like.

The (meth)acryl-based polymer (A) to be used in the invention preferably has a weight average molecular weight of 300,000 to 5,000,000, more preferably 400,000 to 2,000,000, and particularly preferably 500,000 to 1,000,000. In the case where the weight average molecular weight is less than 300,000, the adhesive strength upon peeling increases due to an improvement in wettability to the (functional layer-bearing) transparent conductive film as an adherent, and therefore the adherend may be sometimes damaged in the peeling step (re-peeling), and further an adhesive residue tends to be generated due to small cohesive strength in the pressure-sensitive adhesive layer. On the other hand, in the case where the weight average molecular weight is more than 5,000,000, fluidity of the polymer decreases and wetting to the (functional layer-bearing) transparent conductive film as the adherend becomes insufficient, and thus blister may tend to be generated between the adherend and the carrier film for transparent conductive films. The weight average molecular weight refers to a weight average molecular weight obtained by measuring through gel permeation chromatography (GPC).

### <Isocyanate Crosslinking Agent (B)>

A compound having at least two isocyanate groups may be used as the isocyanate crosslinking agent (B). For example, an aliphatic polyisocyanate, an alicyclic polyisocyanate, or an aromatic polyisocyanate known and commonly used for urethane-forming reaction may be used as the isocyanate crosslinking agent (B).

Examples of the aliphatic polyisocyanate include trimethylene diisocyanate, tetramethylene diisocyanate, hexamethylene diisocyanate, pentamethylene diisocyanate, 1,2-propylene diisocyanate, 1,3-butylene diisocyanate, dodecamethylene diisocyanate, and 2,4,4-trimehylhexamethylene diisocyanate.

Examples of the alicyclic isocyanate include 1,3-cyclopentene diisocyanate, 1,3-cyclohexane diisocyanate, 1,4-cyclohexane diisocyanate, isophorone diisocyanate, hydrogenated diphenylmethane diisocyanate, hydrogenated xylylene diisocyanate, hydrogenated tolylene diisocyanate, and hydrogenated tetramethylxylylene diisocyanate.

Examples of the aromatic diisocyanate include phenylene diisocyanate, 2,4-tolylene diisocyanate, 2,6-tolylene diisocyanate, 2,2′-diphenylmethane diisocyanate, 4,4′-diphenylmethane diisocyanate, 4,4′-toluidine diisocyanate, 4,4′-diphenyl ether diisocyanate, 4,4′-diphenyl diisocyanate, 1,5-naphthalene diisocyanate, and xylylene diisocyanate. Examples also include multimers (such as dimers, trimers, or pentamers) of these diisocyanates and urethane-modified, urea-modified, biuret-modified, allophanate-modified, isocyanurate-modified, or carbodiimide-modified derivatives of these diisocyanates.

Commercially available examples of the isocyanate crosslinking agent (B) include MILLIONATE MT, MILLIONATE MTL, MILLIONATE MR-200, MILLIONATE MR-400, CORONATE L, CORONATE HL, and CORONATE HX (all trade names, manufactured by NIPPON POLYURETHANE INDUSTRY CO., LTD.), and TAKENATE D-110N, TAKENATE D-120N, TAKENATE D-140N, TAKENATE D-160N, TAKENATE D-165N, TAKENATE D-170HN, TAKENATE D-178N, TAKENATE 500, and TAKENATE 600 (all trade names, manufactured by Mitsui Chemicals, Inc.). These compounds may be used singly or in combination of two or more.

In the invention, the content of the isocyanate crosslinking agent (B) is preferably from 1 to 30 parts by weight, more preferably from 3 to 20 parts by weight, even more preferably from 6 to 15 parts by weight, based on 100 parts by weight of the (meth)acryl-based polymer (A). The isocyanate crosslinking agent (B) content of 1 part by weight or more is advantageous in that the isocyanate crosslinking agent (B) can sufficiently crosslink the pressure-sensitive adhesive layer by reacting with the hydroxyl group of the (meth)acryl-based polymer (A) so that the cohesive strength can be increased and zipping can be prevented. It is also advantageous in that cohesive strength can be obtained so that heat resistance can be achieved and adhesive deposit can be reduced. On the other hand, the isocyanate crosslinking agent (B) content of 30 parts by weight or less is advantageous in that excessive crosslinking can be prevented so that cohesive strength can be prevented from being too high and the adherend surface can be prevented from having irregularities. The isocyanate crosslinking agent (B) content of 10 parts by weight or more is also advantageous in that the carrier film of the invention can have a suitable level of adhesive strength and good removability whether the peel rate is high or low when it is peeled off from a (functional layer-bearing) transparent conductive film as the adherend.

These isocyanate crosslinking agent (B) may be used singly or in combination of two or more. A bifunctional isocyanate compound and a trifunctional isocyanate compound may also be used in combination as the isocyanate crosslinking agent (B). The use of a combination of two or more crosslinking agents makes it possible to obtain a pressure-sensitive adhesive layer with higher adhesion reliance.

When a bifunctional isocyanate compound and a trifunctional isocyanate compound are used in combination as the isocyanate crosslinking agent (B), the mixing ratio (weight ratio) of these compounds, specifically, the ratio (weight ratio) of (the bifunctional isocyanate compound)/(the trifunctional isocyanate compound) is preferably from 0.01/99.99 to 50/50, more preferably from 0.05/99.9 to 20/80, even more preferably from 0.1/99.9 to 10/90, further more preferably from 0.1/99.9 to 5/95, still more preferably from 0.1/99.9 to 1/99. When mixed in a ratio within the range, they can form a pressure-sensitive adhesive composition with higher adhesion reliance, which is a preferred mode.

Besides the isocyanate crosslinking agent (B), the pressure-sensitive adhesive composition according to the invention may contain other crosslinking agent if necessary. Examples of such other crosslinking agent include an epoxy crosslinking agent, a melamine-based resin, an aziridine derivative, and a metal chelate compound. These compounds may be used singly or in any combination. It should be noted, however, that even if the above epoxy crosslinking agent or likes other than the isocyanate crosslinking agent (B) is used alone, zipping cannot be sufficiently prevented.

Examples of the epoxy compound include N,N,N′,N′-tetraglycidyl-m-xylenediamine (trade name: TETRAD-X, manufactured by MITSUBISHI GAS CHEMICAL COMPANY, INC.), 1,3-bis(N,N-diglycidylaminomethyl)cyclohexane (trade name: TETRAD-C, manufactured by MITSUBISHI GAS CHEMICAL COMPANY, INC.) and the like. These compounds may be used alone, or two or more kinds of them may be used in combination.

Examples of the melamine-based resin include hexamethylolmelamine and the like. Examples of the aziridine derivative include a commercially available product under the trade name of HDU (manufactured by Sogo Pharmaceutical Co., Ltd.), a commercially available product under the trade name of TAZM (manufactured by Sogo Pharmaceutical Co., Ltd.), a commercially available product under the trade name of TAZO (manufactured by Sogo Pharmaceutical Co., Ltd.) and the like. These compounds may be used alone, or two or more kinds of them may be used in combination.

The metal chelate compound may include a metal component such as aluminum, titanium, nickel, or zirconium and a chelate component such as acetylene, methyl acetoacetate, ethyl acetoacetate, ethyl lactate, or acetyl acetone. These compounds may be used singly or in any combination.

When used in combination with other crosslinking agent than the isocyanate crosslinking agent (B), other crosslinking agents may be used in any amount as long as the effect of the invention is not impaired. Preferably, the total amount of the isocyanate crosslinking agent (B) and the other crosslinking agent is from 1 to 30 parts by weight based on 100 parts by weight of the (meth)acryl-based polymer (A), and the content of the isocyanate crosslinking agent (B) is preferably 50% by weight or more, more preferably 70% by weight or more, even more preferably 90% by weight or more, based on the total weight of the crosslinking agents used.

### (Catalyst (C) Having Iron Active Center)

The pressure-sensitive adhesive composition according to the invention contains a catalyst (C) having an iron active center (hereinafter also referred to as the “iron catalyst (C)”). The iron catalyst (C) to be used is preferably an iron chelate compound, for example, which may be represented by the general formula Fe(X) (Y) (Z). Such an iron chelate compound may be represented by anyone of Fe(X)₃, Fe(X)₂(Y), Fe(X)(Y)₂, and Fe(X)(Y)(Z) depending on the combination between X, Y, and Z. X, Y, and Z each represent a ligand for Fe in the iron chelate compound represented by Fe(X)(Y)(Z). For example, X, Y, or Z may be a β-diketone, examples of which include acetyl acetone, hexane-2,4-dione, heptane-2,4-dione, heptane-3,5-dione, 5-methyl-hexane-2,4-dione, octane-2,4-dione, 6-methylheptane-2,4-dione, 2,6-dimethylheptane-3,5-dione, nonane-2,4-dione, nonane-4,6-dione, 2,2,6,6-tetramethylheptane-3,5-dione, tridecane-6,8-dione, 1-phenyl-butane-1,3-dione, hexafluoroacetyl acetone, and ascorbic acid.

X, Y, or Z may be a β-ketoester, examples of which include methyl acetoacetate, ethyl acetoacetate, n-propyl acetoacetate, isopropyl acetoacetate, n-butyl acetoacetate, sec-butyl acetoacetate, tert-butyl acetoacetate, methyl propionylacetate, ethyl propionylacetate, n-propyl propionylacetate, isopropyl propionylacetate, n-butyl propionylacetate, sec-butyl propionylacetate, tert-butyl propionylacetate, benzyl acetoacetate, dimethyl malonate, and diethyl malonate.

In the invention, other iron catalysts than iron chelate compounds may also be used. For example, a compound including a combination of iron and an alkoxy group, a halogen atom, or an acyloxy group may be used. In the compound including a combination of iron and an alkoxy group, the alkoxy group may be methoxy, ethoxy, n-propoxy, isopropoxy, n-butoxy, sec-butoxy, tert-butoxy, pentyloxy, hexyloxy, heptyloxy, octyloxy, 2-ethylhexyloxy, phenoxy, cyclohexyloxy, benzyloxy, or 1-benzylnaphthyloxy.

In the compound including a combination of iron and a halogen atom, the halogen atom may be fluorine, chlorine, bromine, iodine, or the like.

In the compound including a combination of iron and an acyloxy group, the acyloxy group may be derived from an aliphatic organic acid based on 2-ethylhexanoic acid, octanoic acid, naphthenic acid, resin acid such as abietic acid, neoabietic acid, d-pimaric acid, iso-d-pimaric acid, podocarpic acid, gluconic acid, fumaric acid, citric acid, asparatic acid, α-ketoglutamic acid, malic acid, succinic acid, or an amino acid such as glycine or histidine, or an aromatic fatty acid based on benzoic acid, cinnamic acid or p-oxycinnamic acid.

In the invention, among these compounds, an iron chelate compound having a β-diketone ligand is preferably used as the catalyst (C) having an iron active center, in view of reactivity and curing properties, and in particular, tris(acetylacetonato)iron is preferably used. These compounds may be used singly or in combination of two or more as the iron catalyst (C).

In the invention, the content of the catalyst (C) having an iron active center is preferably from 0.002 to 0.5 parts by weight, more preferably from 0.003 to 0.3 parts by weight, even more preferably from 0.004 to 0.2 parts by weight, based on 100 parts by weight of the (meth)acryl-based polymer (A). The iron catalyst (C) content of 0.002 parts by weight or more based on 100 parts by weight of the (meth)acryl-based polymer (A) is advantageous in that the pressure-sensitive adhesive layer can be crosslinked at a higher rate so that the pressure-sensitive adhesive layer can be rapidly hardened and thus the adherend surface can be prevented from having irregularities. If the content of the iron catalyst (C) is low, curing properties may be insufficient, and the pressure-sensitive adhesive layer may have too high adhesive strength immediately after production, so that an adhesive residue may be more likely to occur when the pressure-sensitive adhesive layer is peeled off, or the adhesive strength may significantly change over time. On the other hand, if the content of the iron catalyst (C) is more than 0.5 parts by weight based on 100 parts by weight of the (meth)acryl-based polymer (A), the necessary amount of the compound (D) capable of undergoing keto-enol tautomerism described below for preventing the deactivation of the iron catalyst (C) may be larger, so that the compound (D) may remain as a residue in the pressure-sensitive adhesive layer sheet, which may cause a significant change in adhesive strength over time.

In the invention, the content of the catalyst (C) having an iron active center is preferably so adjusted that its function can be effectively performed, depending on the content of the isocyanate crosslinking agent (B). Specifically, the added amount of the catalyst (C) having an iron active center is preferably from 0.05 to 12.5 parts by weight, more preferably from 0.075 to 7.5 parts by weight, based on the added amount (100 parts by weight) of the isocyanate crosslinking agent (B).

### (Compound (D) Capable of Undergoing Keto-Enol Tautomerism)

The pressure-sensitive adhesive composition according to the invention may contain (D) a compound capable of undergoing keto-enol tautomerism (hereinafter also referred to as the “keto-enol tautomeric compound (D)”). In some cases, the use of a (meth)acryl-based polymer having a carboxyl group may cause a reduction in the function of the iron catalyst (C) and make it impossible to rapidly complete the crosslinking reaction. The keto-enol tautomeric compound (D) is advantageous in the case that the monomer component used to form the (meth)acryl-based polymer (A) contains a carboxyl group-containing monomer.

The keto-enol tautomeric compound (D) is a compound tautomerizable between a keto form (ketone or aldehyde) and an enol form (see the chemical formula below). Such a compound can act as a chelating agent for the iron catalyst to prevent the carboxyl group from deactivating the function of the catalyst. Specifically, it is conceivable that the carboxyl group can reduce the function of the iron catalyst (C) by changing the chemical structure of the iron catalyst (C), but when the compound (D) capable of undergoing keto-enol tautomerism is existed, the compound (D) can be present near the iron catalyst (C) preferentially over the carboxyl group so that it can protect the iron catalyst (C) to prevent the change of the chemical structure of the iron catalyst (C) and to prevent the deactivation of the iron catalyst (C).

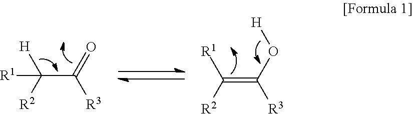

In the formula, R¹, R², and R³ are each hydrogen or a substituent such as an alkyl group, an alkenyl group, or an aryl group. The substituent may contain a heteroatom or a halogen atom in molecule.

Examples of the compound (D) capable of undergoing keto-enol tautomerism include β-ketoesters such as methyl acetoacetate, ethyl acetoacetate, n-propyl acetoacetate, isopropyl acetoacetate, n-butyl acetoacetate, sec-butyl acetoacetate, tert-butyl acetoacetate, methyl propionylacetate, ethyl propionylacetate, n-propyl propionylacetate, isopropyl propionylacetate, n-butyl propionylacetate, sec-butyl propionylacetate, tert-butyl propionylacetate, benzyl acetoacetate, dimethyl malonate, and diethyl malonate; β-diketones such as acetyl acetone, hexane-2,4-dione, heptane-2,4-dione, heptane-3,5-dione, 5-methyl-hexane-2,4-dione, octane-2,4-dione, 6-methylheptane-2,4-dione, 2,6-dimethylheptane-3,5-dione, nonane-2,4-dione, nonane-4,6-dione, 2,2,6,6-tetramethylheptane-3,5-dione, tridecane-6,8-dione, 1-phenyl-butane-1,3-dione, hexafluoroacetyl acetone, and ascorbic acid; acid anhydrides such as acetic anhydride; and ketones such as acetone, methyl ethyl ketone, methyl n-butyl ketone, methyl isobutyl ketone, methyl tert-butyl ketone, methyl phenyl ketone, and cyclohexanone. Among these compounds, β-diketones, which are highly effective in preventing the carboxyl group from deactivating the function of the catalyst, are preferably used, and in particular, acetyl acetone is more preferred.

The content of the compound (D) capable of undergoing keto-enol tautomerism is preferably such that the weight ratio (D/C) of the keto-enol tautomeric compound (D) to the catalyst (C) having an iron active center is from 3 to 70, more preferably from 10 to 70, even more preferably from 20 to 60, furthermore preferably from 40 to 55. If the weight ratio of the keto-enol tautomeric compound (D) to the iron catalyst (C) is more than 70, the content of the keto-enol tautomeric compound (D) can be excessive to the content of the iron catalyst (C), and the keto-enol tautomeric compound (D) can cause a side reaction with the isocyanate crosslinking agent (B) in a liquid composition, so that the number of isocyanate groups available for curing reaction with hydroxyl groups may decrease to such a level that sufficient curing properties cannot be obtained. On the other hand, if the weight ratio of the keto-enol tautomeric compound (D) to the iron catalyst (C) is less than 3, the content of the keto-enol tautomeric compound (D) can be too low relative to the content of the iron catalyst (C), so that the compound (D) may fail to prevent the carboxyl group from deactivating the function of the catalyst.

The compound (D) capable of undergoing keto-enol tautomerism should be added so that the weight ratio (D/C) of the keto-enol tautomeric compound (D) to the catalyst (C) having an iron active center is from 3 to 70. In this case, the compound (D) is preferably added in an amount of 0.15 to 35 parts by weight, more preferably 0.2 to 20 parts by weight, based on 100 parts by weight of the (meth)acryl-based polymer (A). If the added amount of the keto-enol tautomeric compound (D) is more than 35 parts by weight based on 100 parts by weight of the (meth)acryl-based polymer (A), the compound (D) may remain as a residue in the pressure-sensitive adhesive layer to cause a significant change in adhesive strength over time. On the other hand, if the added amount of the keto-enol tautomeric compound (D) is less than 0.15 parts by weight based on 100 parts by weight of the (meth)acryl-based polymer (A), the compound (D) may fail to prevent the carboxyl group from deactivating the function of the catalyst, so that insufficient curing may occur.

Besides the (meth)acryl-based polymer (A), the pressure-sensitive adhesive composition according to the invention may also contain a polyfunctional monomer having two or more unsaturated bonds reactive to radiation. The polyfunctional monomer may be used in the monomer component when the (meth)acryl-based polymer (A) is prepared. In the cases, a (meth)acryl-based polymer (A) is cross-linked by irradiation with radiation. Examples of the polyfunctional monomer having two or more radiation-reactive unsaturated bonds in a molecule include polyfunctional monomers having two or more radiation-reactive unsaturated bonds of one or two or more kinds which can be cross-linked (cured) by irradiation with radiation, such as a vinyl group, an acryloyl group, a methacryloyl group and a vinylbenzyl group. Generally, those having ten or less radiation-reactive unsaturated bonds are suitably used as the polyfunctional monomer. These compounds may be used alone, or two or more kinds of them may be used in combination.

Specific examples of the polyfunctional monomer include ethylene glycol di(meth)acrylate, diethylene glycol di(meth)acrylate, tetraethylene glycol di(meth)acrylate, neopentyl glycol di(meth)acrylate, 1,6-hexanediol di(meth)acrylate, trimethylolpropane tri(meth)acrylate, pentaerythritol tri(meth)acrylate, dipentaerythritol hexa(meth)acrylate, divinyl benzene, N,N′-methylenebisacrylamide and the like.

A blending amount of the polyfunctional monomer to be used in the invention is preferably 30 parts by weight or less, more preferably from 1 to 30 parts by weight, and more preferably from 2 to 25 parts by weight, based on 100 parts by weight (solid content) of the (meth)acryl-based polymer (A).

Examples of the radiation include ultraviolet rays, laser beams, α-rays, β-rays, γ-rays, X-rays, electron beams and the like, and ultraviolet rays are suitably used from the viewpoints of controllability, satisfactory handleability and costs. More preferably, ultraviolet rays having a wavelength of 200 to 400 nm are used. It is possible to irradiate ultraviolet rays using appropriate light sources such as a high-pressure mercury lamp, a microwave-excited type lamp and a chemical lamp. In the case of using ultraviolet rays as the radiation, a photopolymerization initiator is blended with a pressure-sensitive adhesive composition.

The photopolymerization initiator may be a substance which forms a radical or cation by irradiation with ultraviolet rays having an appropriate wavelength which can cause a polymerization reaction according to the kind of a radiation-reactive component.

Examples of the photoradical polymerization initiator include benzoins such as benzoin, benzoin methyl ether, benzoin ethyl ether, o-methylbenzoyl benzoate-p-benzoin ethyl ether, benzoin isopropyl ether and α-methylbenzoin; acetophenones such as benzyl dimethyl ketal, trichloroacetophenone, 2,2-diethoxyacetophenone and 1-hydroxycyclohexyl phenyl ketone; propiophenones such as 2-hydroxy-2-methylpropiophenone and 2-hydroxy-4′-isopropyl-2-methylpropiophenone; benzophenones such as benzophenone, methylbenzophenone, p-chlorobenzophenone and p-dimethylaminobenzophenone; thioxanthones such as 2-chlorothioxanthone, 2-ethylthioxanthone and 2-isopropylthioxanthone; acylphosphine oxides such as bis(2,4,6-trimethylbenzoyl)-phenylphosphine oxide, 2,4,6-trimethylbenzoyldiphenylphosphine oxide and (2,4,6-trimethylbenzoyl)-(ethoxy)-phenylphosphine oxide; benzyl, dibenzosuberone, α-acyloxime ester and the like. These compounds may be used alone, or two or more kinds of them may be used in combination.

Examples of the photocation polymerization initiator include onium salts such as an aromatic diazonium salt, an aromatic iodonium salt and an aromatic sulfonium salt; organic metal complexes such as an iron-allene complex, a titanocene complex and an arylsilanol-aluminum complex; a nitrobenzyl ester, a sulfonic acid derivative, a phosphoric acid ester, a phenolsulfonic acid ester, diazonaphthoquinone and N-hydroxyimide sulfonate. These compounds may be used alone, or two or more kinds of them may be used in combination. The photopolymerization initiator is usually blended in an amount of 0.1 to 10 parts by weight, and preferably 0.2 to 7 parts by weight, based on 100 parts by weight of the (meth)acryl-based polymer (A).

It is also possible to use in combination with auxiliary photopolymerization initiators such as amines. Examples of the auxiliary photopolymerization initiator include 2-dimethylaminoethyl benzoate, dimethylaminoacetophenone, ethyl p-dimethylaminobenzoate, isoamyl p-dimethylaminobenzoate and the like. These compounds may be used alone, or two or more kinds of them may be used in combination. The auxiliary photopolymerization initiator is preferably blended in an amount of 0.05 to 10 parts by weight, and more preferably 0.1 to 7 parts by weight, based on 100 parts by weight of the (meth)acryl-based polymer (A).

The pressure-sensitive adhesive composition to be used in the invention may contain other known additives. For example, it is possible to appropriately blend powders such as a colorant and a pigment, a surfactant, a plasticizer, a tackifier, a low-molecular weight polymer, a surface lubricant, a leveling agent, an antioxidant, a corrosion inhibitor, a photostabilizer, an ultraviolet absorber, a polymerization inhibitor, a silane coupling agent, an inorganic or organic filler, a metal powder, a granule and a foil-shaped substance according to the use applications.

The pressure-sensitive adhesive layer used in the invention, which can be made from the pressure-sensitive adhesive composition described above. The carrier film for a (functional layer-bearing) transparent conductive film of the invention is obtained by forming such a pressure-sensitive adhesive layer on a support (base material, base material layer). In that case, the (meth)acryl-based polymer is generally cross-linked after applying the pressure-sensitive adhesive composition. It is also possible to transfer a pressure-sensitive adhesive layer made of the pressure-sensitive adhesive composition after cross-linking to a support and the like.

A non-limiting example of a method of forming the pressure-sensitive adhesive layer on the support (also referred to as the base material or the base material layer) includes applying the pressure-sensitive adhesive composition to the support (wherein, for example, the solid content of the coating is preferably 20% by weight or more, more preferably 30% by weight or more.) and removing the polymerization solvent and other materials by drying to form the pressure-sensitive adhesive layer on the support. Thereafter, aging may be performed for the purpose of adjusting transfer of the component of the pressure-sensitive adhesive layer and adjusting the cross-linking reaction. In the case of producing a carrier film for a transparent conductive film by applying the pressure-sensitive adhesive composition on the support, one or more kinds of solvents other than the polymerization solvent may be newly added to the pressure-sensitive adhesive composition so as to be uniformly applied on the support.

It is possible to use, as the method of applying a pressure-sensitive adhesive composition, a known method to be used in the production of a pressure-sensitive adhesive tape or the like. Specific examples thereof include roll coating, gravure coating, reverse coating, roll brushing, spray coating, and air knife coating methods and the like.

The drying conditions for the drying of the pressure-sensitive adhesive composition applied to the support may be appropriately determined depending on the components or concentration of the pressure-sensitive adhesive composition, the type of the solvent in the composition, or other factors. As a non-limiting example, the pressure-sensitive adhesive composition may be dried at 80 to 200° C. for about 10 seconds to about 30 minutes.

In the case of blending the photopolymerization initiator serving as an optional component mentioned above, the pressure-sensitive adhesive composition is applied on one or both surfaces of the support (base material, base material layer), and irradiated with light, and thus a pressure-sensitive adhesive layer can be obtained. Usually, a pressure-sensitive adhesive layer can be obtained by photopolymerization through irradiation with ultraviolet rays having an illuminance of 1 to 200 mW/cm² at a wavelength of 300 to 400 nm in a dose of about 400 to 4,000 mJ/cm².

In the carrier film of the invention for transparent conductive films, the pressure-sensitive adhesive layer preferably has a thickness of 5 to 50 μm, more preferably 10 to 30 μm. Within the ranges, a good balance between the adhesion and the removability can be achieved, which is a preferred mode. The pressure-sensitive adhesive layer is formed on at least one side of the support (base material layer) used in the invention by coating or other means to form a film, a sheet, a tape, or other shape.

### (2) Support

The support (base material) (represented by numeral 4 in FIG. 1), which forms the carrier film of the invention for transparent conductive films, may be of any type. Examples of the support that may be used include a paper-based support such as a paper sheet; a fiber-based support such as a cloth, a nonwoven fabric, or a net (which may be made of any material, such as Manila hemp, rayon, polyester, or pulp fibers, which may be appropriately selected); a metal-based support such as a metal foil or a metal sheet; a plastic-based support such as a plastic film or sheet; a rubber-based support such as a rubber sheet; a foam material such as a foam sheet; a laminate of any combination thereof (such as a laminate of a plastic-based support and any other support or a laminate of plastic films (or sheets)); and other thin materials.

Examples of materials that may be used to form the plastic film or sheet include olefin resins including a monomer unit derived from an α-olefin, such as polyethylene (PE), polypropylene (PP), ethylene-propylene copolymers, and ethylene-vinyl acetate copolymers (EVA); polyester resins such as polyethylene terephthalate (PET), polyethylene naphthalate (PEN), and polybutylene terephthalate (PBT); polyvinyl chloride (PVC); vinyl acetate resins; polyphenylene sulfide (PPS); amide resins such as polyamide (nylon) and fully aromatic polyamide (aramid); polyimide resins; and polyether ether ketone (PEEK). These materials may be used singly or in combination of two or more. In particular, the polyester resins have strong toughness, processability and transparency. In a more preferred mode, therefore, any of the polyester resins are used to form the carrier film for transparent conductive films so that its ability to be handled or inspected can be improved.

There is no particular limitation on the polyester-based resin as long as it can be formed into a sheet, film or the like, and examples thereof include polyester films made of polyethylene terephthalate (PET), polyethylene naphthalate or polybutylene terephthalate. These polyester-based resins may be used alone (homopolymer), or two or more kinds of them may be used in combination after polymerization (copolymer, etc.). In the invention, since the polyester-based resin is particularly used as the carrier film for a transparent conductive film, polyethylene terephthalate is preferably used as the material of the support. Therefore, when polyethylene terephthalate is used, the obtained carrier film for a transparent conductive film is excellent in strong toughness, processability and transparency and thus workability are improved, resulting in a preferred aspect.

The support general used has a thickness of 75 to 300 μm, preferably 75 to 200 μm, more preferably from 80 to 140 μm, and particularly preferably from 90 to 130 μm. When the thickness is within the above range, it is possible to retain a shape of the transparent conductive films which has no stiffness and is likely to be flexible by using the carrier film for a transparent conductive film in the state of attaching to the (functional layer-bearing) transparent conductive film, and generation of defects such as wrinkles and scratches in processing step, transporting step and the like can be prevented. Therefore, the carrier film for transparent conductive films is useful.

The support may be optionally subjected to a mold release treatment using a releasing agent such as a silicone-based, a fluorine-based, long chain alkyl-based or fatty acid amide-based, or silica powder or the like; an antifouling treatment; an easy adhesion treatment such as an acid treatment, an alkali treatment, a primer treatment, a corona treatment, a plasma treatment or an ultraviolet treatment, and an antistatic treatment such as a coating, kneading or vapor deposition treatment, or the like. Particularly when an antistatic treatment is performed, an antistatic layer is preferably provided between the support and the pressure-sensitive adhesive layer.

In order to improve adhesion between the pressure-sensitive adhesive layer and the support, a surface of the support may be subjected to a corona treatment or the like. The support may be subjected to a rear surface treatment.

If necessary, a separator treated with a silicone-based, a fluorine-based, long chain alkyl-based or fatty acid amide-based release agent may be attached to the surface of the pressure-sensitive adhesive of the carrier film of the invention for use on a (functional layer-bearing) transparent conductive film in order to protect the adhesive surface. The base material constituting the separator includes paper and a plastic film, and a plastic film is suitably used from the viewpoint of excellent surface smoothness. There is no particular limitation on the film as long as it is a film capable of protecting the pressure-sensitive adhesive layer, and examples thereof include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, an ethylene-vinyl acetate copolymer film and the like.

If necessary, the support for the separator may be subjected to an easy adhesion treatment such as an alkali treatment, a primer treatment, a corona treatment, a plasma treatment, or an ultraviolet treatment, and an antistatic treatment such as a coating, kneading or vapor deposition treatment. In particular, when an antistatic treatment is performed, an antistatic treatment layer is preferably provided between the support and the release agent.

### 2. (Functional Layer-Bearing) Transparent Conductive Film

As shown in FIG. 1, the transparent conductive film (thin layer substrate) 1 may be a film including a transparent conductive layer 1a and a support 1b.

The support 1b may be a plastic film or a substrate made of glass or other materials (e.g., a substrate (component) in the form of a sheet, a film, or a plate). In particular, the support 1b should be a plastic film. The thickness of the support 1b is preferably, but not limited to, about 10 to about 200 μm, more preferably about 15 to about 150 μm.

The material for the plastic film may be, but not limited to, various transparent plastic materials. Examples of the material for the transparent plastic film include polyester resins such as polyethylene terephthalate and polyethylene naphthalate, acetate resins, polyethersulfone resins, polycarbonate resins, polyamide resins, polyimide resins, polyolefin resins, (meth)acrylic resins, polyvinyl chloride resins, polyvinylidene chloride resins, polystyrene resins, polyvinyl alcohol resins, polyarylate resins, and polyphenylene sulfide resins. In particular, polyester resins, polyimide resins, and polyethersulfone resins are preferred.

The surface of the substrate 1b may be previously subject to sputtering, corona discharge treatment, flame treatment, ultraviolet irradiation, electron beam irradiation, chemical treatment, etching treatment such as oxidation, or undercoating treatment such that the adhesion of the transparent conductive layer 1a formed thereon to the substrate 1b can be improved. If necessary, the substrate 1b may also be subjected to dust removing or cleaning by solvent cleaning, ultrasonic cleaning or the like, before the transparent conductive layer 1a is formed.

The constituent material of the transparent conductive layer 1a is not particularly limited, and a metal oxide of at least one metal selected from the group consisting of indium, tin, zinc, gallium, antimony, titanium, silicon, zirconium, magnesium, aluminum, gold, silver, copper, palladium and tungsten is used. The metal oxide may further contain metal atoms shown in the above-mentioned group as necessary. For example, indium oxide (ITO) containing tin oxide, tin oxide containing antimony, and the like are preferably used, ITO is more preferably used. ITO preferably contains 80 to 99% by weight of indium oxide and 1 to 20% by weight of tin oxide.

The thickness of the transparent conductive layer 1a is preferably, but not limited to, from 10 to 300 nm, more preferably from 15 to 200 nm.

The transparent conductive layer 1a may be formed using known conventional methods, while the methods are not particularly limited. Examples of such methods include vacuum deposition, sputtering, and ion plating. Any appropriate method may be used depending on the required film thickness.

If desired, an undercoat layer, an oligomer blocking layer, or other layer may be provided between the transparent conductive layer 1a and the support 1b.

The transparent conductive film 1 having the transparent conductive layer 1a can be used as a substrate (optical member) for an optical device. There is no particular limitation on the substrate for an optical device, as long as it is a substrate having optical characteristics, and examples thereof include a substrate (member) constituting devices such as display devices (liquid crystal display devices, organic EL (electroluminescence) display devices, plasma display panels (PDPs), electronic paper, etc.) and input devices (touch panels, etc.) and a substrate (member) to be used in these devices. In recent years, such a substrate for an optical device has lost rigidity because of a trend toward a reduction in thickness. Thus, such a substrate for an optical device can be easily bent or deformed during a manufacturing process, a transporting process, or other processes. The carrier film of the invention may be attached to such a substrate and used, so that the geometry of the substrate can be preserved and the occurrence of defects can be prevented, which is a preferred mode.

A functional layer 2 may be provided on the side of the transparent conductive film opposite to its side where the transparent conductive layer 1a is provided.

For example, an antiglare (AG) or anti-reflection (AR) layer for improving visibility may be provided as the functional layer. The material used to form the antiglare layer may be of any type such as an ionizing radiation-curable resin, a thermosetting resin, or a thermoplastic resin. The antiglare layer preferably has a thickness of 0.1 to 30 μm. The anti-reflection layer may be made of titanium oxide, zirconium oxide, silicon oxide, magnesium fluoride, or other materials. The anti-reflection layer may be composed of two or more layers.

A hard coating (HC) layer may also be provided as the functional layer. The material used to form the hard coating layer is preferably a cured coating made from curable resin such melamine-based resin, urethane-based resin, alkyd-based resin, acrylic-based resin, or silicone-based resin. The hard coating layer preferably has a thickness of 0.1 to 30 μm. A thickness of 0.1 μm or more is preferred to impart hardness. The antiglare layer or the anti-reflection layer or an anti-blocking layer may also be provided on the hard coating layer. A hard coating layer may have an antiglare function, an anti-reflection function, an anti-blocking function or an oligomer-blocking function.

The thickness of the functional layer-bearing transparent conductive film (including the thickness of the functional layer) is preferably 210 μm or less, more preferably 150 μm or less. When the carrier film of the invention is used on the (functional layer-bearing) transparent conductive film (adherend) with a thickness in the above range, the geometry of the transparent conductive film can be preserved even in a case where its thickness is very small, so that the occurrence of defects such as wrinkles or scratches can be prevented, which is a preferred mode.

The pressure-sensitive adhesive layer used in the invention preferably has an adhesive strength of 0.1 to 3.5 N/50 mm, more preferably 0.2 to 2.5 N/50 mm, even more preferably 0.2 to 1.0 N/50 mm, to the functional layer at any of a low peeling rate (0.3 m/minute) and a high peeling rate (10 m/minute) (which corresponds to the adhesive strength to the surface A in FIG. 1 at room temperature (25° C.)). Within the ranges, the transparent conductive film can be prevented from undergoing deformation or other geometrical changes in the process of peeling off the carrier film from the transparent conductive film, which is a preferred mode. Specifically, if the adhesive strength exceeds 3.0 N/50 mm, the transparent conductive film may tend to undergo deformation or other geometrical changes in the process of peeling off the carrier film from the transparent conductive film, which is not preferred.

### 3. Laminate

The invention relates to a laminate, including:

a carrier film for transparent conductive films; and

a transparent conductive film placed on the carrier film,

wherein

the carrier film is a carrier film described in the description,

the transparent conductive film includes a support and a transparent conductive layer, and

an adhesive surface of the pressure-sensitive adhesive layer of the carrier film is attached to a surface of the support opposite to a surface of the support in contact with the transparent conductive layer.

The invention relates to a laminate, including:

a carrier film for transparent conductive films; and

a transparent conductive film placed on the carrier film,

wherein

the carrier film is a carrier film described in the description,

the transparent conductive film includes a support, a transparent conductive layer, and a functional layer provided on a surface of the support opposite to a surface of the support in contact with the transparent conductive layer, and

an adhesive surface of the pressure-sensitive adhesive layer of the carrier film is attached to a surface of the functional layer opposite to a surface of the functional layer in contact with the support.

The laminate of the invention can be formed using the carrier film and the transparent conductive film described above.

### EXAMPLES

Examples and the like specifically illustrating the constitution and effect of the invention will be descried below, but the invention is not limited thereto. Evaluation items in Examples and the like were measured by the following procedures. The contents are shown in Tables 1 and 2, the evaluation results are shown in Table 2.

### Example 1

### Preparation of Acryl-Based Polymer (A)

In a four-necked flask equipped with a stirring blade, a thermometer, a nitrogen gas introducing tube and a condenser, 100 parts by weight of 2-ethylhexyyl acrylate (2EHA), 10 parts by weight of 4-hydroxybutyl acrylate (HBA), 0.2 parts by weight of 2,2′-azobisisobutyronitrile as a polymerization initiator and 205 parts by weight of ethyl acetate were charged and a nitrogen gas was introduced while stirring mildly. Then, a polymerization reaction was performed for about 4 hours while maintaining a liquid temperature inside the flask at about 63° C. to prepare an acryl-based polymer (A1) solution (35% by weight). The acryl-based polymer (A1) had a weight average molecular weight of 600,000 and a glass transition temperature (Tg) of −67° C.

### <Preparation of Pressure-Sensitive Adhesive Solution>

The acryl-based polymer (A1) solution (about 35% by weight) was diluted with ethyl acetate to 29% by weight. Based on 100 parts by weight of the acryl-based polymer (solid basis) in the resulting solution, 4 parts by weight of a trimethylolpropane-tolylene diisocyanate trimer adduct (CORONATE L (trade name) manufactured by Nippon Polyurethane Industry Co., Ltd.), 0.01 parts by weight of tris(acetylacetonato)iron (NĀCEM IRON(III) (trade name) manufactured by Nihon Kagaku Sangyo Co., Ltd.) as an iron catalyst, and 0.69 parts by weight of acetyl acetone as a compound capable of undergoing keto-enol tautomerism were added to the resulting solution. The mixture was stirred at about 25° C. for about 1 minute to give an acrylic pressure-sensitive adhesive composition (1).

### <Production of Carrier Film for Transparent Conductive Film>

The above acrylic pressure-sensitive adhesive composition (1) was applied on one surface of a polyethylene terephthalate (PET) base material (thickness: 125 μm, support) and then heated at 150° C. for 90 seconds to form a pressure-sensitive adhesive layer having a thickness of 20 μm. Then, the surface of the pressure-sensitive adhesive layer was attached to the silicone-treated surface of a PET release liner (25 μm in thickness) whose one side was silicone-treated. The resulting laminate was stored at 50° C. for 2 days, so that a carrier film for transparent conductive films was obtained. The release liner was removed before the carrier film was used.

### Examples 2 to 20 and Comparative Examples 1 to 2

Carrier films for transparent conductive films were prepared using the same process as in Example 1, except that the type or the contents of the monomer component used to form the acryl-based polymer, and the type or the contents of the crosslinking agent, the catalyst, and the keto-enol tautomerism compound in the pressure-sensitive adhesive composition were changed as shown in Tables 1 and 2.

### <Measurement of Weight Average Molecular Weight (Mw) of Acryl-Based Polymer>

A weight average molecular weight of the produced polymer was measured by gel permeation chromatography (GPC).

Apparatus: HLC-8220GPC manufactured by TOSOH CORPORATION

### Column:

Sample column; TSKguardcolumn Super HZ-H (one column) and TSKgel Super HZM-H (two columns), manufactured by TOSOH CORPORATION Reference column; TSKgel Super H-RC (one column), manufactured by TOSOH CORPORATION
Flow rate: 0.6 ml/minute
Injection amount: 10 μl
Column temperature: 40° C.

### Eluent: THF

Concentration of injected sample: 0.2% by weight
Detector: differential refractometer

The weight average molecular weight was calculated in terms of polystyrene.

### <Measurement of Glass Transition Temperature (Tg)>

A glass transition temperature Tg (° C.) was determined by the following equation using the following literature value as the glass transition temperature Tgn (° C.) of a homopolymer by each monomer.

Equation: 1/(Tg+273)=Σ[Wn/(Tgn+273)]

wherein Tg (° C.) denotes a glass transition temperature of a copolymer, Wn (−) denotes a weight fraction of each monomer, Tgn (° C.) denotes a glass transition temperature of a homopolymer by each monomer, and n denotes a kind of each monomer.

2-ethylhexyl acrylate (2EHA): −70° C.

isononyl acrylate (i-NA): −58° C.

Butyl acrylate (BA): −55° C.

Ethyl acrylate (EA): −20° C.

4-hydroxybutyl acrylate (HBA): −32° C.

2-hydroxyethyl acrylate (HEA): −15° C.

2-hydroxyethyl methacrylate (HEMA): 55° C.

Acrylic acid: 106° C.

“Synthesis/Design and Development of New Application of Acrylic Resin” (published by Publishing Department of Chubu Management Development Center) was referred as the literature value.

The carrier film obtained in each of the examples and the comparative examples for transparent conductive films was evaluated as described below.

### <Observation of the Surface State of Functional Layer>

The surface of the pressure-sensitive adhesive layer of the carrier film for transparent conductive films was attached to the hard coat surface (HC surface) of a hard coat film (HC film) (KB-FILM G01 (a film including a PET film and a hard coat layer provided thereon) manufactured by KIMOTO CO., LTD.) by pressure-bonding at 0.25 MPa and an attaching rate of 2.0 m/minute using a laminator. Subsequently, the product was heated at 140° C. for 90 minutes and then allowed to stand at room temperature (25° C.) for 30 minutes or more. Subsequently, the carrier film for transparent conductive films was peeled off from the HC film. The HC surface of the HC film was then visually observed under a fluorescent lamp, and whether or not the HC surface has irregularities was evaluated according to the criteria below.

⊙: No irregularities are observed on the HC surface.

◯: Few irregularities are observed on the HC surface.

x: Irregularities are clearly observed on the HC surface.

### <Zipping>

A 50-mm-wide and 100-mm-long HC film (KB-FILM G01 (a film including a PET film and a hard coat layer provided thereon) manufactured by KIMOTO CO., LTD.) was fixed onto a SUS plate (SUS 430BA). The HC film was used as an adherend. The surface of the pressure-sensitive adhesive layer of the carrier film for transparent conductive films was attached to the HC surface of the HC film (by pressure-bonding at 0.25 MPa and an attaching rate of 2.0 m/minute using a laminator). Subsequently, the product was heated at 140° C. for 90 minutes and then allowed to stand at room temperature (25° C.) for 30 minutes or more. In the same environment, the carrier film was then peeled off over a length of 80 mm from the HC film using a universal tensile tester under the conditions of a peel rate of 0.3 m/minute and a peel angle of 180° when the peel strength (N/50 mm) was measured. Whether or not zipping occurs was determined from the formula below using the data obtained from the measurement of the peel strength of the last 60 mm part.

ΔF/F(Ave)<15%: No zipping occurs (which is expressed by the symbol: ◯)

ΔF/F(Ave)>15%: Zipping occurs (which is expressed by the symbol: x)

F(Ave): Average peel strength

F(Max): Maximum peel strength

F(Min): Minimum peel strength

ΔF: F(Max)−F(Min)

### <Measurement of Adhesive Strength>

A 50-mm-wide, 100-mm-long, transparent conductive film (ELECRYSTA V150M-OFAD2 (a film including a PET film, a transparent conductive layer provided on one side thereof, and a functional layer provided on the other side thereof) manufactured by Nitto Denko Corporation) was fixed onto a SUS plate (SUS 430BA). The transparent conductive film was used as an adherend. The surface of the pressure-sensitive adhesive layer of the carrier film for transparent conductive films was attached to the functional layer surface of the transparent conductive film (by pressure-attaching at 0.25 MPa and an attaching rate of 2.0 m/minute using a laminator). Subsequently, the product was heated at 140° C. for 90 minutes and then allowed to stand at room temperature (25° C.) for 30 minutes or more. In the same environment, the carrier film was then peeled off from the transparent conductive film under the conditions of a peel rate of 0.3 m/minute (low peel rate), a peel rate of 10 m/minute (high peel rate), and a peel angle of 180° when the peel strength (N/50 mm) was measured.

The peel strength was evaluated according to the following ranges.

From 0.2 N/50 mm to less than 1.0 N/50 mm: More preferred range (expressed by the symbol ⊙)

From 1.0 N/50 mm to less than 3.0 N/50 mm: Preferred range (expressed by the symbol ◯)

3.0 N/50 mm or more: Undesired range (expressed by the symbol x)

TABLE 1

| | Monomer component | | | | | | | | | |
|---|---|---|---|---|---|---|---|---|---|---|
| | | | | | Hydroxyl | | | Carboxyl | Weight | |
| | | | | | group- | | | group- | average | |
| Acryl- | | | | | containing | | | containing | molecular | |
| based | Alkyl acrylate | | | | monomer | | | monomer | weight | Tg |
| polymer | 2EHA | i-NA | BA | EA | HBA | HEA | HEMA | AA | (Mw) | (° C.) |
| A1 | 100 | — | — | — | 10 | — | — | — | 600,000 | −67 |
| A2 | 100 | — | — | — | — | 4 | — | — | 550,000 | −68 |
| A3 | 100 | — | — | — | 10 | — | — | 0.02 | 610,000 | −67 |
| A4 | 100 | — | — | — | 10 | — | — | 0.1 | 600,000 | −67 |
| A5 | 100 | — | — | — | 10 | — | — | 0.5 | 600,000 | −67 |
| A6 | 100 | — | — | — | 10 | — | — | 1 | 620,000 | −66 |
| A7 | 100 | — | — | — | 10 | — | — | 2 | 600,000 | −65 |
| A8 | 100 | — | — | — | 15 | — | — | — | 600,000 | −66 |
| A9 | 100 | — | — | — | 12 | — | 3 | — | 610,000 | −64 |
| A10 | 100 | — | — | — | 16 | — | 4 | 0.05 | 630,000 | −62 |
| A11 | 55 | — | 45 | — | 10 | — | — | — | 700,000 | −61 |
| A12 | 60 | — | — | 40 | 10 | — | — | — | 600,000 | −51 |
| A13 | — | 100 | — | — | 10 | — | — | — | 600,000 | −56 |
| A14 | — | — | 100 | — | 10 | — | — | — | 690,000 | −53 |
| A15 | 100 | — | — | — | 7 | — | — | — | 620,000 | −68 |
| A′ | — | — | 90 | — | — | — | — | 10 | 750,000 | −45 |

(Notes)
2EHA: 2-ethylhexyl acrylate, i-NA: isononyl acrylate, BA: butyl acrylate, EA: ethyl acrylate, HBA: 4-hydroxybutyl acrylate, HEA: 2-hydroxyethyl acrylate, HEMA: 2-hydroxyethyl methacrylate, AA: acrylic acid.

TABLE 2

| | | | | | | | | | | Evaluations | | | |
|---|---|---|---|---|---|---|---|---|---|---|---|---|---|
| | | | Crosslinking agent | | | | Catalyst (parts) | | Keto-enol | Surface | | | |
| | Acryl-based | | Isocyanate | | Epoxy | | Iron | | tautomerism | state of | | Low | High |
| | polymer | | crosslinking | | crosslinking | | catalyst | Tin | compound | functional | | rate | rate |
| Formulation | Type | Parts | agent (B) | Parts | agent | Parts | (C) | catalyst | (D) (parts) | layer | Zipping | peel | peel |
| Example 1 | A1 | 100 | C/L | 4 | — | — | 0.01 | — | 0.69 | ◯ | ◯ | ◯ | X |
| Example 2 | A1 | 100 | C/L | 8 | — | — | 0.01 | — | 0.69 | ◯ | ◯ | ◯ | ◯ |
| Example 3 | A1 | 100 | C/L | 12 | — | — | 0.01 | — | 0.69 | ⊙ | ◯ | ⊙ | ⊙ |
| Example 4 | A1 | 100 | C/L | 15 | — | — | 0.01 | — | 0.69 | ⊙ | ◯ | ⊙ | ⊙ |
| Example 5 | A2 | 100 | C/HX | 4 | — | — | 0.01 | — | 0.69 | ◯ | ◯ | ◯ | X |
| Example 6 | A1 | 100 | MR-400 | 9 | — | — | 0.01 | — | 0.69 | ⊙ | ◯ | ⊙ | ◯ |
| Example 7 | A1 | 100 | C/L + | 11 + 0.5 | — | — | 0.01 | — | 0.69 | ⊙ | ◯ | ⊙ | ⊙ |
| | | | Takenate | | | | | | | | | | |
| | | | 500 | | | | | | | | | | |
| Example 8 | A3 | 100 | C/L | 12 | — | — | 0.01 | — | 0.69 | ⊙ | ◯ | ⊙ | ⊙ |
| Example 9 | A4 | 100 | C/L | 12 | — | — | 0.01 | — | 0.69 | ⊙ | ◯ | ⊙ | ⊙ |
| Example 10 | A5 | 100 | C/L | 12 | — | — | 0.01 | — | 0.69 | ⊙ | ◯ | ⊙ | ⊙ |
| Example 11 | A6 | 100 | C/L | 12 | — | — | 0.01 | — | 0.69 | ⊙ | ◯ | ⊙ | ⊙ |
| Example 12 | A7 | 100 | C/L | 12 | — | — | 0.01 | — | 0.69 | ⊙ | ◯ | ⊙ | ⊙ |
| Example 13 | A8 | 100 | C/L | 14 | — | — | 0.01 | — | 0.69 | ⊙ | ◯ | ⊙ | ⊙ |
| Example 14 | A9 | 100 | C/L | 12 | — | — | 0.01 | — | 0.69 | ⊙ | ◯ | ⊙ | ⊙ |
| Example 15 | A10 | 100 | C/L | 13 | — | — | 0.01 | — | 0.69 | ⊙ | ◯ | ⊙ | ⊙ |
| Example 16 | A11 | 100 | C/L | 12 | — | — | 0.01 | — | 0.69 | ⊙ | ◯ | ⊙ | ⊙ |
| Example 17 | A12 | 100 | C/L | 12 | — | — | 0.01 | — | 0.69 | ⊙ | ◯ | ⊙ | ◯ |
| Example 18 | A13 | 100 | C/L | 12 | — | — | 0.01 | — | 0.69 | ⊙ | ◯ | ⊙ | ◯ |
| Example 19 | A14 | 100 | C/HX | 12 | — | — | 0.01 | — | 0.69 | ⊙ | ◯ | ⊙ | ◯ |
| Example 20 | A15 | 100 | C/L | 8 | — | — | 0.01 | — | 0.69 | ◯ | ◯ | ◯ | ◯ |
| Comparative | A′ | 100 | — | — | T/C | 11 | — | — | — | ⊙ | X | ⊙ | ⊙ |
| Example 1 | | | | | | | | | | | | | |
| Comparative | A1 | 100 | C/L | 12 | — | — | — | 0.02 | 8.25 | X | ◯ | ⊙ | ⊙ |
| Example 2 | | | | | | | | | | | | | |

(Notes) As for the crosslinking agent,

C/L represents an isocyanate crosslinking agent CORONATE L (trade name) manufactured by Nippon Polyurethane Industry Co., Ltd. (trimethylolpropane-tolylene diisocyanate trimer adduct),

C/HX an isocyanate crosslinking agent CORONATE HX (trade name) manufactured by Nippon Polyurethane Industry Co., Ltd. (an isocyanurate of hexamethylene diisocyanate),

MR-400 an isocyanate crosslinking agent MILLIONATE MR-400 (trade name) manufactured by Nippon Polyurethane Industry Co., Ltd. (polymeric MDI (polymethylene polyphenyl polyisocyanate)),

Takenate 500 an isocyanate crosslinking agent Takenate 500 (trade name) manufactured by Mitsui Chemicals, Inc. (1,3-bis(isocyanatomethyl)benzene), and

T/C an epoxy crosslinking agent TETRAD-C manufactured by MITSUBISHI GAS CHEMICAL COMPANY, INC.

As for the catalyst,

the iron catalyst is tris(acetylacetonato)iron (NĀCEM IRON(III) (trade name) manufactured by Nihon Kagaku Sangyo Co., Ltd.), and

the tin catalyst is dioctyltin dilaurate (EMBILIZER OL-1 (trade name) manufactured by Tokyo Fine Chemical CO., LTD.). The keto-enol tautomerism compound is acetyl acetone.

### EXPLANATION OF REFERENCE NUMERALS

1a Transparent conductive layer
1b Support (base material)
1 Transparent conductive film
2 Functional layer
3 Pressure-sensitive adhesive layer
4 Support (base material)
10 Functional layer-bearing transparent conductive film
20 Carrier film for functional layer-bearing transparent conductive film
A Adhesive surface opposite to the surface in contact with the support

What is claimed is:

1. A carrier film for transparent conductive films, comprising a support and a pressure-sensitive adhesive layer provided on at least one side of the support, wherein
the pressure-sensitive adhesive layer is made from a pressure-sensitive adhesive composition comprising:
a (meth)acryl-based polymer (A) having a glass transition temperature of −50° C. or lower and obtained by polymerization of a monomer component containing an alkyl(meth)acrylate and a hydroxyl group-containing monomer;
an isocyanate crosslinking agent (B); and
a catalyst (C) having an iron active center.

2. The carrier film according to claim 1, wherein the monomer component used to form the (meth)acryl-based polymer (A) contains 65% by weight or more of the alkyl(meth)acrylate and 1 to 25% by weight of the hydroxyl group-containing monomer based on the total weight of the monomer component.

3. The carrier film according to claim 1, wherein the pressure-sensitive adhesive composition contains 1 to 30 parts by weight of the isocyanate crosslinking agent (B) based on 100 parts by weight of the (meth)acryl-based polymer (A).

4. The carrier film according to claim 1, wherein the catalyst (C) having an iron active center is an iron chelate compound.

5. The carrier film according to claim 1, wherein the pressure-sensitive adhesive composition contains 0.002 to 0.5 parts by weight of the catalyst (C) having an iron active center based on 100 parts by weight of the (meth)acryl-based polymer (A).

6. The carrier film according to claim 1, wherein the monomer component used to form the (meth)acryl-based polymer (A) further contains a carboxyl group-containing monomer.

7. The carrier film according to claim 6, wherein the monomer component contains 0.005 to 5% by weight of the carboxyl group-containing monomer based on the total weight of the monomer component.

8. The carrier film according to claim 1, wherein the pressure-sensitive adhesive composition further comprises a compound (D) capable of undergoing keto-enol tautomerism.

9. The carrier film according to claim 8, wherein the compound (D) capable of undergoing keto-enol tautomerism is a β-diketone.

10. The carrier film according to claim 9, wherein the weight ratio (D/C) of the compound (D) capable of undergoing keto-enol tautomerism to the catalyst (C) having an iron active center is from 3 to 70.

11. A laminate, comprising:
the carrier film according to claim 1; and
a transparent conductive film placed on the carrier film, wherein
a surface of the pressure-sensitive adhesive layer of the carrier film is attached at least one surface of the transparent conductive film.

12. The laminate according to claim 11, wherein
the transparent conductive film comprises a support and a transparent conductive layer, and
the surface of the pressure-sensitive adhesive layer of the carrier film is attached to a surface of the support opposite to a support surface in contact with the transparent conductive layer.

13. The laminate according to claim 11, wherein
the transparent conductive film comprises a support, a transparent conductive layer and a functional layer provided on a surface of the support opposite to a support surface in contact with the transparent conductive layer, and
the surface of the pressure-sensitive adhesive layer of the carrier film is attached to a surface of the functional layer opposite to a functional layer surface in contact with the support.
